(19) United States
(12) Patent Application Publication
(10) Pub. No.: US 2025/0001585 A1
(43) Pub. Date: Jan. 2, 2025

(54) EXOSKELETON AND METHOD

(71) Applicant: FESTOOL GMBH, Wendlingen (DE)

(72) Inventors: Bernward OTTEN, Hamburg (DE); Mauritz FETHKE, Hamburg (DE); Simon ZELL, Ulm (DE)

(21) Appl. No.: 18/682,394

(22) PCT Filed: Aug. 12, 2022
(86) PCT No.: PCT/EP2022/072712

§ 371 Date: Feb. 8, 2024

(30) Foreign Application Priority Data
Aug. 13, 2021 (DE) 10 2021 208 905.4

(51) Int. Cl. B25J 9/00

(52) U.S. Cl. CPC B25J 9/0006; B25J 9/0009

(57) ABSTRACT

An exoskeleton including a base section for attachment to a torso of a human body, a support section movably coupled to the base section for supporting an arm of the human body, an actuator device acting on the support section for providing a support force for the arm. The base section includes a back part, a pelvic strap and a force transmission arrangement, which force transmission arrangement provides a force transmission path from the back part to the pelvic strap in order to transmit, to the pelvic strap, a reaction force transmitted from the support section to the back part. The force transmission arrangement includes a joint arrangement for providing at least one rotational and/or translational degree of freedom between the back part and the pelvic strap. The force transmission arrangement includes a rigid force transmission element extending from the back part to the pelvic strap.

The invention relates to an exoskeleton comprising: a base section for attachment to a torso of a human body, a support section movably coupled to the base section for supporting an arm of the human body, an actuator device, in particular a pneumatic actuator device, acting on the support section for providing a support force for the arm, wherein the base section comprises a back part, a pelvic strap and a force transmission arrangement extending from the back part to the pelvic strap, which force transmission arrangement provides a force transmission path from the back part to the pelvic strap in order to transmit, to the pelvic strap, a reaction force transmitted from the support section to the back part.

The reaction force can also be referred to as user force. The reaction force is, for example, a force that acts on the support section from the user's arm. For example, the reaction force is an interaction force acting back from the arm to the support section. Due to the principle of actio and reactio (also known as the interaction principle), the support section is acted upon by the arm with the reaction force acting in the opposite direction to the support force when the support force is applied to the arm itself. Expediently, the reaction force is opposite to the support force.

Exoskeletons are known from DE102017112436B4, U.S. Pat. No. 10,864,102B2 and U.S. Pat. No. 10,918,559B2.

It is an object of the invention to provide an exoskeleton with which reliable support for the user can be achieved.

The object is solved by an exoskeleton according to claim 1. The force transmission arrangement comprises a joint arrangement for providing at least one rotational and/or translational degree of freedom between the back part and the pelvic strap. Preferably, the joint arrangement comprises at least one joint for providing the at least one rotational and/or translational degree of freedom between the back part and the pelvic strap. Preferably, the force transmission path runs via the at least one joint. The force transmission arrangement further comprises a rigid force transmission element extending from the back part towards the pelvic strap, over which rigid force transmission element the force transmission path runs. Preferably, the force transmission path runs sequentially—i.e. in series-via the force transmission element and via the at least one joint.

The reaction force can be transmitted to the pelvic strap via the force transmission path, allowing the exoskeleton to provide reliable support for the user. Since the force transmission path is transmitted via the one rigid force transmission element, further rigid force transmission elements parallel to the one rigid force transmission element can expediently be dispensed with. Preferably, in addition to the one rigid force transmission element, there is no further rigid force transmission element extending from the back part to the pelvic strap. The fact that no further rigid force transmission elements are required between the back part and the pelvic strap, and the fact that the at least one joint is present, preferably ensures that the user can move easily with the exoskeleton in place and that an impairment of wearing comfort can be avoided.

Expediently, the extension of the force transmission element in the width direction is less than the extension of the back part in the width direction.

Advantageous further developments are the subject of the subclaims.

The invention further relates to a method according to claim 17.

Further exemplary details and exemplary embodiments are explained below with reference to the figures. Thereby shows

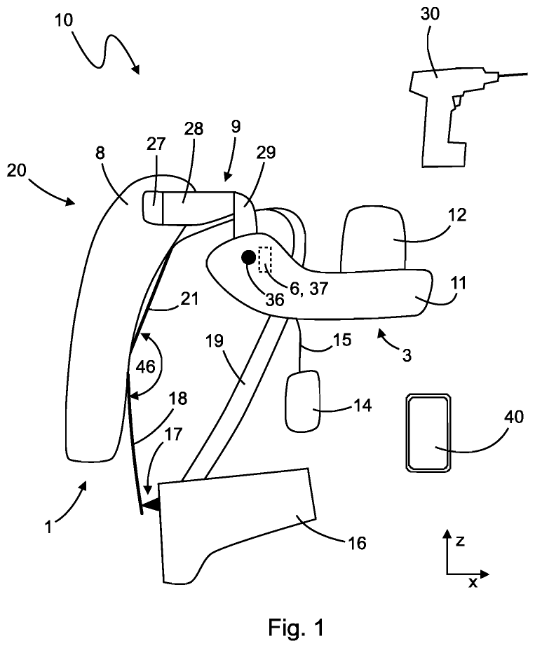

FIG. 1 a schematic side view of an exoskeleton device,

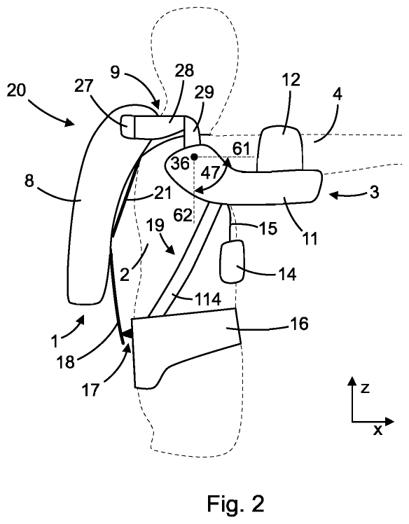

FIG. 2 a schematic side view of an exoskeleton worn by a user,

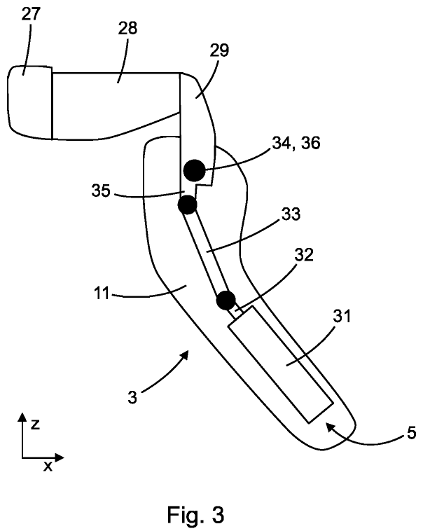

FIG. 3 a schematic detailed view of a support section of the exoskeleton,

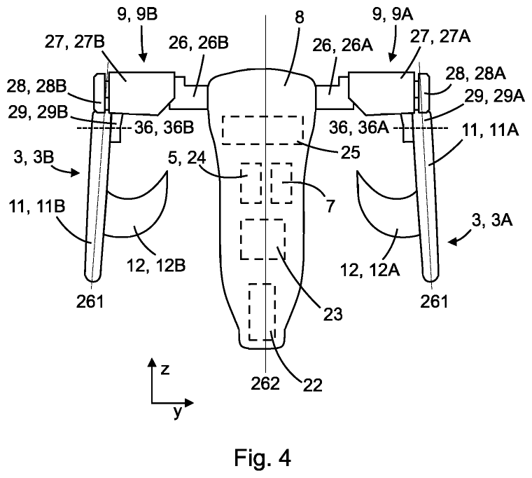

FIG. 4 a schematic rear view of the exoskeleton,

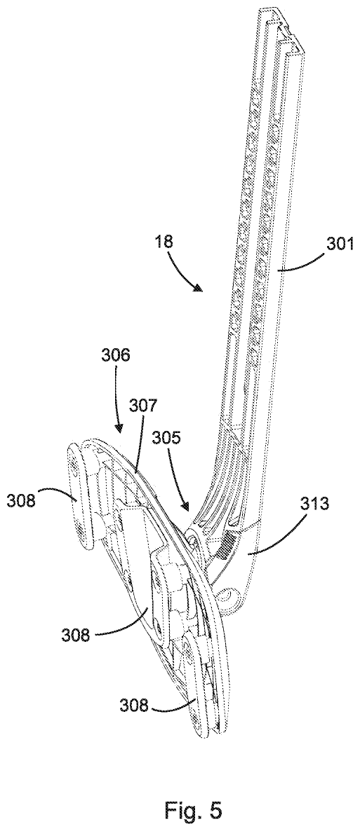

FIG. 5 a perspective view of a force transmission element and a joint,

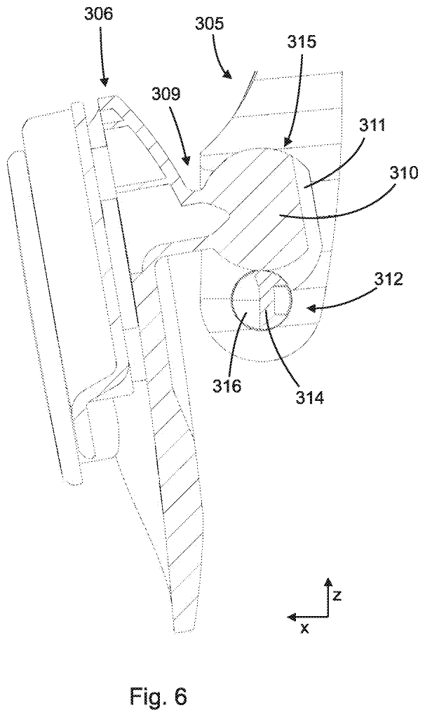

FIG. 6 a sectional view of the joint,

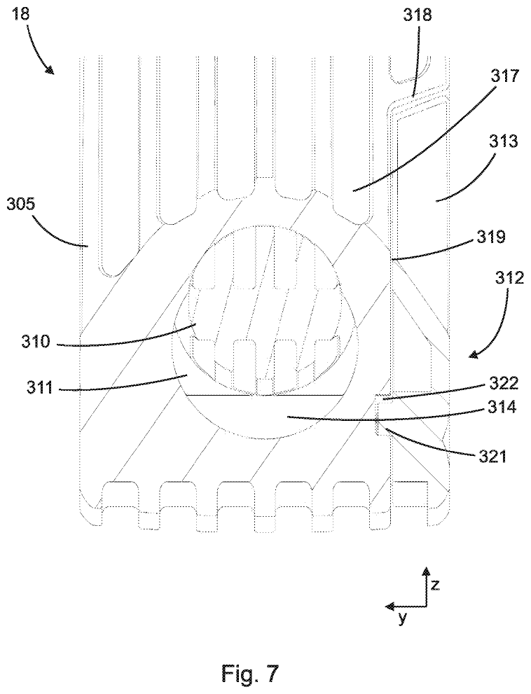

FIG. 7 a further sectional view of the joint,

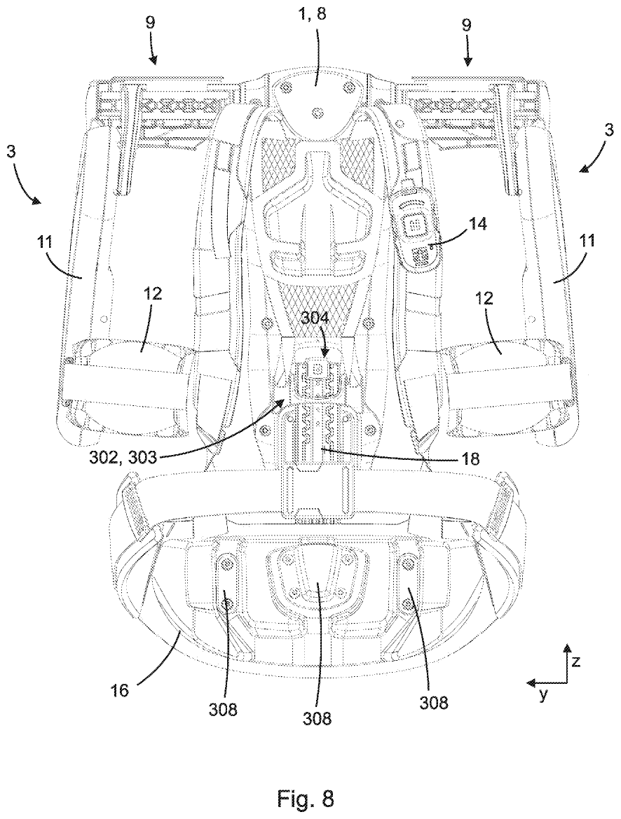

FIG. 8 a front view of an exemplary design of the exoskeleton,

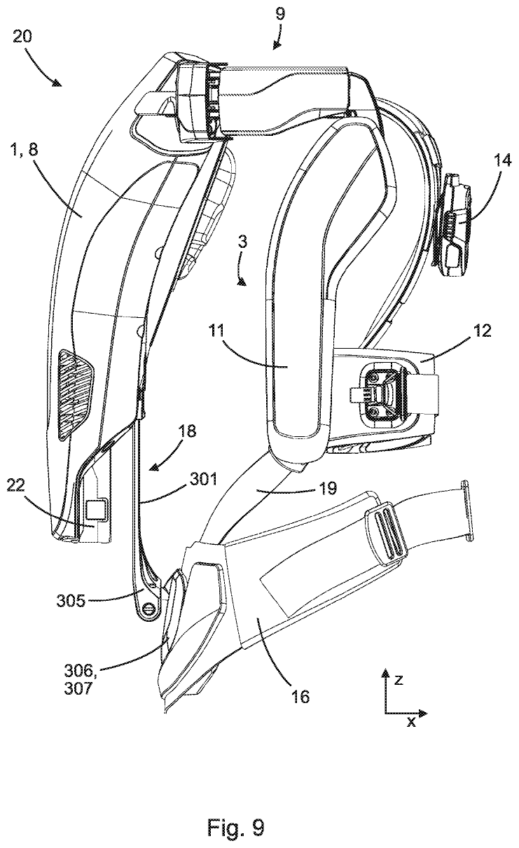

FIG. 9 a side view of the exemplary design of the exoskeleton,

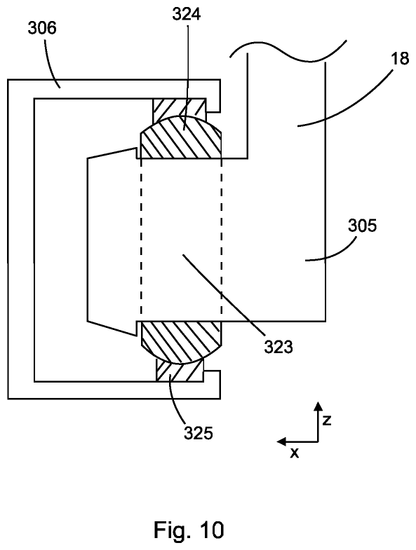

FIG. 10 a schematic sectional view of a variant of the joint,

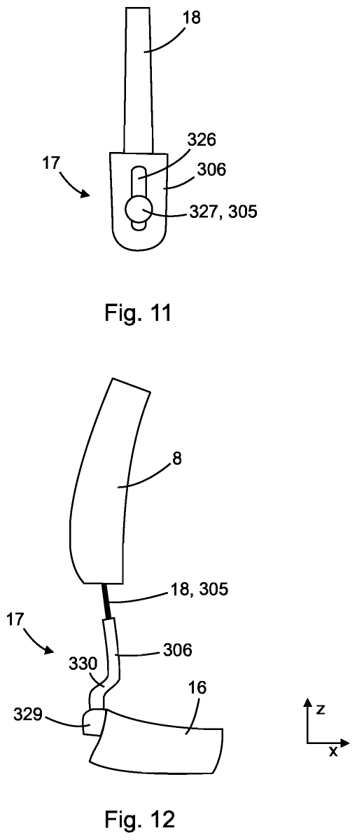

FIG. 11 a schematic view of another variant of the joint,

FIG. 12 a schematic side view of another variant of the joint, together with the pelvic strap and the back part,

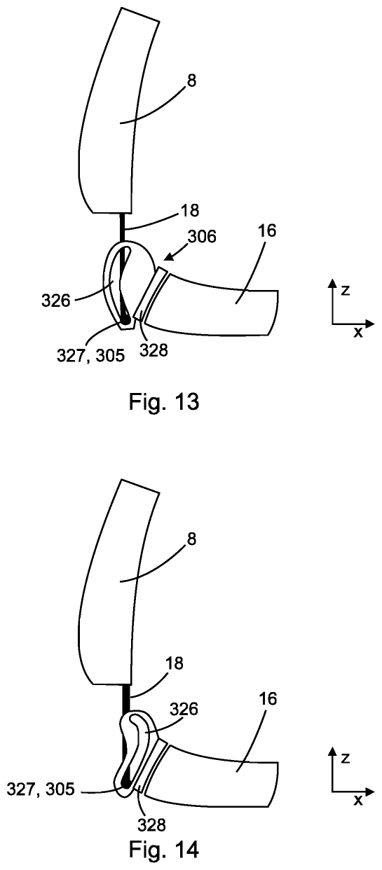

FIG. 13 a schematic side view of a further variant of the joint, together with the pelvic strap and the back part, and

FIG. 14 a schematic side view of another variant of the joint, together with the pelvic strap and the back part.

In the following explanations, reference is made to the spatial directions x-direction, y-direction and z-direction, which are drawn in the figures and are aligned orthogonally to each other. The z-direction can also be referred to as the vertical direction, the x-direction as the depth direction and the y-direction as the width direction.

FIG. 1 shows a schematic representation of an exoskeleton device 10 comprising an exoskeleton 20 and optionally a tool 30 and/or a mobile device 40. The exoskeleton 20 can also be provided on its own. The tool 30 and/or the mobile device 40 are exemplarily provided separately from the exoskeleton 20, i.e. in particular not mechanically connected to the exoskeleton 20. The tool 30 is, for example, a power tool, in particular a cordless screwdriver and/or a drill and/or a grinder. The mobile device 40 is preferably a smartphone or a tablet. Optionally, the exoskeleton 20 is configured to communicate with the tool 30 and/or the mobile device 40, in particular wirelessly.

As an example, the exoskeleton 20 is aligned in an upright orientation with its vertical axis (which in particular runs parallel to a base section axis 62) parallel to the z-direction. In particular, the exoskeleton 20 is aligned in the upright orientation with its sagittal axis parallel to the x-direction. In a state in which the user has put on the exoskeleton 20, the sagittal axis of the exoskeleton 20 runs parallel to the sagittal axis of the user, i.e. in particular parallel to a direction from the rear—i.e. in particular the back of the user—to the front—i.e. in particular the chest of the user. The horizontal axis of the exoskeleton 20 runs in particular in the width direction of the exoskeleton 20 and/or parallel to the y-direction. In a state in which the user has put on the exoskeleton 20, the horizontal axis of the exoskeleton 20 runs parallel to the horizontal axis of the user, i.e. in particular parallel to a direction from a first shoulder of the user to a second shoulder of the user. The vertical axis of the exoskeleton 20, the sagittal axis of the exoskeleton 20 and the horizontal axis of the exoskeleton 20 are aligned orthogonally to each other.

The exoskeleton device 10 is designed in particular for manual and/or industrial use. Preferably, the exoskeleton device 10 is not designed for medical and/or therapeutic use.

The exoskeleton 20 is an active exoskeleton and in particular has an internal energy source from which the energy for the support force is provided. In particular, the exoskeleton 20 is an active exoskeleton for actively supporting the user's shoulder joint.

The exoskeleton 20 comprises a base section 1 for attachment to a body section of a human body of a user. By way of example, the base section 1 serves to be attached to the torso 2 of the human body.

The base section 1 comprises a main section and a textile carrying system, which is in particular detachably attached to the main section. By way of example, the main section serves to be worn on the back of the human body by means of the textile carrying system, in particular in a backpack-like manner. The main section comprises a back part 8, which is in particular elongated and which is expediently aligned with its longitudinal axis vertically and/or in the longitudinal direction of the user's back. For example, the longitudinal direction of the back part 8 extends along the longitudinal direction of the back. The main section further comprises a force transmission element 18, which is in particular strip-shaped and/or rigid and extends downwards from the back part 8 to a pelvic strap 16 in order to mechanically couple the back part 8 to the pelvic strap 16. The force transmission element 18 is expediently used to transmit a reaction force, which is transmitted from a support section 3 to the back part 8, further to the pelvic strap 16. As an example, the back part 8 is tubular and/or backpack-shaped. The back part 8 is in particular rigid. In particular, the back part 8 comprises an expediently rigid back part housing, which is made, for example, from an in particular rigid plastic and/or as a hard shell. The back part 8 expediently serves to transmit a force from the support section 3 to the force transmission element 18 and/or to accommodate components for controlling the support force.

The support section 3 can expediently be referred to as an arm actuator.

The force transmission element 18 is exemplarily sword-shaped and can also be referred to as a sword. Expediently, the force transmission element 18 is designed to be adjustable relative to the back part 8, in particular in order to change the vertical extent of the main section and/or a force transmission element angle 46 between the force transmission element 18 and the back part 8 facing the user's back. Expediently, the force transmission element 18 is mounted for translational and/or rotational movement relative to the back part 8 and, in particular, can be moved into various translational and/or rotational positions relative to the back part 8 and, in particular, can be locked. The translational movement is in particular vertical. The rotational movement is expediently performed about an adjustment axis aligned parallel to the y-direction.

The textile carrying system comprises, by way of example, the pelvic strap 16 and/or at least one, preferably two, shoulder straps 19. The pelvic strap 16 expediently forms a loop so that, when worn, it surrounds the torso 2, in particular the hips, of the user. Each shoulder strap 19 extends exemplarily from the main section, in particular from the back part 8, to the pelvic strap 16, expediently over a respective shoulder of the user when the exoskeleton 20 is worn.

The exoskeleton 20 further comprises, by way of example, a force transmission element joint 17, via which the force transmission element 18 is attached to the pelvic strap 16. The force transmission element joint 17 is designed, for example, as a ball joint and can be referred to as a sacral joint. When the exoskeleton 20 is worn, the force transmission element joint 17 is arranged in the lower back region of the user, in particular centered in the width direction.

By way of example, the textile carrying system also comprises a back net 21, which is arranged on the side of the back part 8 facing the user's back. When the exoskeleton 20 is worn, the back net 21 lies against the user's back, in particular at least partially and/or in the upper back region.

The exoskeleton 20 further comprises the support section 3 movably coupled to the base section 1 for supporting a limb, in particular an arm 4, of the human body of the user. In particular, the support section 3 is designed to be attached to the limb, in particular the arm 4, of the user. The support section 3 comprises, by way of example, an in particular rigid arm part 11 and an arm attachment 12 arranged on the arm part 11, which is designed, by way of example, as an arm shell. The arm part 11 is exemplarily elongated and, when worn, is aligned with its longitudinal axis in the direction of the longitudinal axis of the user's arm. As an example, the arm part 11 extends from the shoulder of the user to the elbow area of the user. The exoskeleton 20, in particular the arm part 11, ends at the elbow area of the user. The arm attachment 12 is used in particular to attach the support section 3 to the arm 4, in particular the upper arm, of the user. In particular, the arm shell surrounds the upper arm of the user, in particular at least partially, so that the upper arm can be held in the arm shell with a strap. The user's forearm is expediently not attached to the exoskeleton 20.

As an example, the support section 3 is mounted so that it can pivot about a horizontal pivot axis relative to the base section 1, in particular relative to the back part 8. As an example, the support section 3 is mounted directly on a shoulder part 29. The horizontal pivot axis can also be referred to as the lifting axis 36. When the exoskeleton 20 is worn, the lifting axis 36 is located in the area of the user's shoulder. In particular, the exoskeleton 20 is designed to support the user's shoulder joint with the support section 3. When the exoskeleton 20 is worn, the user can perform a lifting movement with his arm 4 supported by the support section 3 by pivoting the support section 3 about the lifting axis 36. In particular, the lifting axis 36 can be aligned in the y-direction. Expediently, the lifting axis 36 always lies in a horizontal plane, for example an x-y plane. In particular, a horizontal plane is to be understood as an exactly horizontal plane and/or a plane that is tilted by a maximum of 10 degrees, 7 degrees or 5 degrees relative to a horizon.

The pivot angle 47 of the support section 3 about the lifting axis 36 relative to the base section 1 should also be referred to as the lifting angle. The pivot angle 47 has a reference value, in particular a minimum value, when the support section 3 is oriented downwards (in the case of a vertically oriented exoskeleton 20) and increases continuously up to a maximum value when the support section 3 is pivoted upwards. The minimum value is in particular a minimum value in terms of amount, for example zero.

As an example, the pivot angle 47 is defined as an angle between a support section axis 61 and a base section axis 62. The support section axis 61 extends in the longitudinal direction of the support section 3. Exemplarily, the support section axis 61 extends from the lifting axis 36 in the direction of the arm attachment 12. In a state in which the user has put on the exoskeleton 20, the support section axis 61 expediently extends parallel to an upper arm axis of the arm 4 supported by the support section 3. The base section axis 62 expediently represents a vertical axis of the base section 1 and extends vertically downwards, in particular in a vertical orientation of the base section 1, for example in a state in which the user has put on the exoskeleton 20 and is standing upright. As an example, the pivot angle 47 lies in a z-x plane, for example when the user is standing upright and the arms are being lifted forwards.

The exoskeleton 20 comprises, by way of example, a shoulder joint arrangement 9, via which the support section 3 is attached to the base section 1, in particular the back part 8. The shoulder joint arrangement 9 expediently comprises a joint chain with one or more pivot bearings for defining one or more vertical axes of rotation. By means of the joint chain, it is expediently possible to pivot the support section 3 relative to the base section 1, in particular relative to the back part 8, in a preferably horizontal pivot plane, for example about a virtual vertical axis of rotation. In particular, the joint chain enables the user to pivot his arm 4, which is supported by the support section 3, about a vertical axis of rotation running through the user's shoulder, whereby the support section 3 is moved along with the arm 4. As an example, the joint chain is designed to be passive, so that the exoskeleton 20 does not provide any active support force in the direction of the horizontal pivot movement when the arm is pivoted in the preferably horizontal pivot plane.

The shoulder joint arrangement 9 is expediently arranged and/or designed in such a way that it defines a free space which, when the exoskeleton 20 is worn, is located above the shoulder of the user wearing the exoskeleton 20, so that the user can align his arm, which is supported by the support section 3, vertically upwards through the free space past the shoulder joint arrangement 9.

By way of example, the shoulder joint arrangement 9 comprises an inner shoulder joint section 27, which is mounted so as to be pivotable about a first vertical axis of rotation relative to the base section 1, in particular to the back part 8, by means of a first pivot bearing of the shoulder joint arrangement 9. By way of example, the shoulder joint arrangement 9 further comprises an outer shoulder joint section 28, which is mounted so as to be pivotable about a second vertical axis of rotation relative to the inner shoulder joint section 27 by means of a second pivot bearing of the shoulder joint arrangement 9. By way of example, the shoulder joint arrangement 9 further comprises a shoulder part 29 which is mounted so as to be pivotable about a third vertical axis of rotation relative to the outer shoulder joint section 28 by means of a third pivot bearing of the shoulder joint arrangement 9. Preferably, the inner shoulder joint section 27, the outer shoulder joint section 28 and the shoulder part 29 in the shoulder joint arrangement 9 are kinematically coupled to one another as the joint chain in such a way that the pivot angle of the inner shoulder joint section 27 relative to the base section 1 determines the pivot angle of the outer shoulder joint section 28 relative to the inner shoulder joint section 27 and/or the pivot angle of the shoulder part 29 relative to the outer shoulder joint section 28.

FIG. 3 shows a schematic detailed view of the support section 3, with components arranged within the arm part visibly shown. The arm part 11 expediently comprises an arm part housing, which is in particular rigid and made of plastic, for example.

The exoskeleton 20 comprises an actuator device 5 acting on the support section 3 to provide a support force for the limb, exemplarily for the user's arm. By way of example, the actuator device 5 is arranged at least partially in the arm part 11.

The actuator device 5 is an active actuator device. Expediently, the exoskeleton 20 provides the support force by means of the actuator device 5 with a force component acting upwards in the direction of the pivoting movement about the lifting axis 36, which pushes the user's arm 4 upwards in the direction of the pivoting movement.

Preferably, the actuator device 5 comprises an actuator unit with an actuator member 32. The actuator unit can apply an actuator force to the actuator member 32 in order to provide the support force. The actuator member 32 is coupled to an eccentric section 35 arranged eccentrically to the lifting axis 36. The eccentric section 35 is part of the shoulder part 29, for example. By coupling the actuator member 32 to the eccentric section 35, the actuator force provides a torque of the support section 3 about the lifting axis 36 relative to the base section 1 and/or the shoulder part 29. Due to this torque, the support section 3 presses against the limb, in particular the arm 4, of the user, in particular upwards, and thus provides the support force acting on the limb, in particular the arm 4, of the user.

As an example, the actuator device 5 has a coupling element 33, in particular designed as a push rod, via which the actuator member 32 is coupled to the eccentric section 35.

Preferably, the actuator device 5 is a pneumatic actuator device and the actuator unit is expediently designed as a pneumatic drive cylinder 31. The actuator member 32 is the piston rod of the drive cylinder 31.

Alternatively, the actuator device may not be designed as a pneumatic actuator device. For example, the actuator device can be designed as a hydraulic and/or electric actuator device and, expediently, comprise a hydraulic drive unit and/or an electric drive unit as the actuator unit.

The drive cylinder 31, the actuator member 32 and/or the coupling element 33 are preferably arranged in the arm part housing.

The exoskeleton 20 expediently comprises a lifting pivot bearing 34, which provides the lifting axis 36. As an example, the support section 3 is attached to the shoulder joint arrangement 9 via the lifting pivot bearing 34.

FIG. 4 shows a rear view of the exoskeleton 20, whereby the textile support system and the force transmission element 18 are not shown.

The exoskeleton 20 comprises, by way of example, one or more batteries 22, a compressor 23, a valve unit 24 and/or a compressed air tank 25, which are expediently part of the base section 1 and are arranged in particular in the back part housing.

By way of example, the rechargeable battery 22 is arranged at the bottom of the back part 8 and, in particular, is inserted into a rechargeable battery holder of the back part 8 from below. Expediently, the compressed air tank 25 is arranged in an upper region in the back part 8, exemplarily (in particular in the longitudinal direction of the back part 8 and/or vertical direction) above the valve unit 24, the control device 7, the compressor 23 and/or the rechargeable battery 22. The valve unit 24 and/or the control device 7 is (in particular in the longitudinal direction of the back part 8 and/or vertical direction) expediently arranged above the compressor and/or above the rechargeable battery 22. The compressor 23 is arranged (in particular in the longitudinal direction of the back part 8 and/or vertical direction) above the battery 22.

The battery 22 serves as an electrical power supply for the exoskeleton 20, in particular for the compressor 23, the valve unit 24, a sensor device 6 and/or a control device 7.

The compressor 23 is designed to compress air in order to generate compressed air. The compressed air tank 25 is designed to store compressed air—in particular the compressed air generated by the compressor 23.

The valve unit 24 expediently comprises one or more electrically operable valves and is designed in particular to influence a pneumatic connection from the compressed air tank 25 to a pressure chamber of the pneumatic drive cylinder 31, in particular to selectively establish and/or block the pneumatic connection. Expediently, the valve unit 24 is further designed to influence a pneumatic connection from the compressed air tank 25 to the environment of the exoskeleton 20 and/or a pneumatic connection from the pressure chamber of the drive cylinder 31 to the environment of the exoskeleton 20, in particular to selectively establish and/or block the pneumatic connection. The valve unit 24 is expediently part of the actuator device 5.

The exoskeleton 20 further comprises a sensor device 6. As an example, the sensor device 6 comprises an angle sensor 37 for detecting the angle of the support section 3 relative to the base section 1, in particular the arm part 11 relative to the shoulder part 29. This angle should also be referred to as the pivot angle 47 or the lifting angle. The angle sensor 37 is used in particular to detect the angle of the support section 3 about the lifting axis 36. The angle sensor 37 is designed, for example, as an incremental encoder and is arranged in particular on the lifting pivot bearing 34, in particular in the arm part 11 and/or in the shoulder part 29.

Preferably, the sensor device 6 further comprises at least one pressure sensor for detecting the pressure prevailing in the pressure chamber of the drive cylinder 31 and/or the pressure prevailing in the compressed air tank 25. The at least one pressure sensor is expediently arranged in the back part 8 and/or in the arm part 11.

The exoskeleton device 10, in particular the exoskeleton 20, expediently comprises a control device 7, which for example comprises a microcontroller or is designed as a microcontroller. The control device 7 is used in particular to control the actuator device 5, in particular the valve unit 24, in order to control the provision of the support force. Furthermore, the control device 7 is used to read out the sensor device 6, in particular to read out data recorded by the sensor device 6 and/or to communicate with the tool 30 and/or the mobile device 40. Preferably, the control device 7 is designed to adjust the pressure prevailing in the pressure chamber of the drive cylinder 31 by actuating the valve unit 24, in particular to closed-loop control the pressure, for example taking into account a pressure value recorded by means of the pressure sensor. In particular, the control device 7 is designed to increase the pressure prevailing in the pressure chamber by actuating the valve unit 24 in order to increase the support force and/or to reduce the pressure prevailing in the pressure chamber by actuating the valve unit 24 in order to reduce the support force.

According to a preferred embodiment, the control device 7 is designed to adjust the support force on the basis of the pivot angle 47 of the support section 3 detected in particular by means of the angle sensor 37. Expediently, the user can use his muscle strength to change the pivot angle 47 of the support section 3 by pivoting his arm 4, thereby influencing in particular the provision of the support force. In particular, the support force is low enough so that the user can change the pivot angle 47 of the support section 3 by pivoting his arm 4 using his muscle strength. The support force is limited, for example, by the design of the pneumatic system, in particular the compressor, and/or by the control device 7.

The control device 7 is preferably part of the exoskeleton 20 and is exemplarily arranged in the base section 1, in particular in the back part 8. Optionally, the control device 7 can be at least partially implemented in the mobile device 40.

As an example, the exoskeleton 20 comprises an operating element 14, which is expediently attached to the base section 1 via an operating element cable 15. The user can control the exoskeleton 20 via the operating element 14 and, in particular, activate, deactivate and/or set the support force to one of several possible force values greater than zero.

As an example, the exoskeleton 20 further has a connecting element 26, via which the shoulder joint arrangement 9 is attached to the base section 1, in particular the back part 8. The connecting element 26 is exemplarily designed as a pull-out element. The connecting element 26 is expediently adjustable in its position relative to the base section 1, in particular relative to the back part 8, in order to be able to adapt the position of the shoulder joint arrangement 9 and the support section 3 to the shoulder width of the user. In particular, the position of the connecting element 26 can be adjusted by pushing or pulling the connecting element 26 in or out of the back part 8.

By way of example, the exoskeleton 20 has a first support section 3A, a first shoulder joint arrangement 9A and a first connecting element 26A, as well as a second support section 3B, a second shoulder joint arrangement 9B and a second connecting element 26B. The components whose reference signs are provided with the suffix “A” or “B” are expediently each designed in correspondence with the components provided with the same reference sign number but without the suffix “A” or “B”, for example identical or mirror-symmetrical, so that the explanations in this regard apply in correspondence.

The first support section 3A, the first shoulder joint arrangement 9A and the first connecting element 26A are arranged on a first, exemplarily the right, side (in width direction) of the base section 1, and serve to support a first, in particular the right, arm of the user.

The second support section 3B, the second shoulder joint arrangement 9B and the second connecting element 26B are arranged on a second, exemplarily the left, side (in width direction) of the base section 1 and serve to support a second, in particular the left, arm of the user.

The first support section 3A comprises a first arm part 11A, a first arm attachment 12A and/or a first actuator unit, in particular a first drive cylinder.

The second support section 3A comprises a second arm part 11B, a second arm attachment 12B and/or a second actuator unit, in particular a second drive cylinder.

Preferably, the control device 7 is designed to set a first support force for the first support section 3A by means of the first actuator unit and to set a second support force for the second support section 3B by means of the second actuator unit, which second support force is expediently different from the first support force.

The first shoulder joint arrangement 9A comprises a first inner shoulder joint section 27A, a first outer shoulder joint section 28A and a first shoulder part 29A. The second shoulder joint arrangement 9B comprises a second inner shoulder joint section 27B, a second outer shoulder joint section 28B and a second shoulder part 29B.

The first support section 3A is pivotable about a first horizontal lifting axis 36A relative to the base section 1 and the second support section 3B is pivotable about a second horizontal lifting axis 36B relative to the base section 1.

In FIG. 2, the exoskeleton 20 is shown in a state in which it is worn by a user, in particular worn as intended. By the formulation that the user is wearing the exoskeleton 20, in particular wearing it as intended, it is meant that the user has put on the exoskeleton, i.e. put it on, by way of example in that the user is wearing the back part 8 on his back like a backpack, has put on the pelvic strap 16 around his hips, the shoulder strap or shoulder straps 19 run over the shoulder or shoulders of the user and/or one or both arms of the user are attached to the respective support section 3 with a respective arm attachment 12.

By way of example, the exoskeleton 20 is designed to support the user during a lifting movement of a respective arm, i.e. during an upwardly directed pivoting of the respective support section 3 about a respective lifting axis 36, with a respective support force acting in particular upwards. Furthermore, the exoskeleton 20 is expediently designed to support or counteract the user during a lowering movement, i.e. during a downward pivoting of the respective support section 3 about a respective lifting axis 36, with a respective support force acting in particular upwards, or to deactivate or reduce the respective support force during the lowering movement.

Preferably, the base section 1 comprises a force transmission arrangement extending from the back part 8 to the pelvic strap 16. The force transmission arrangement provides a force transmission path from the back part 8 to the pelvic strap 16 in order to further transmit, to the pelvic strap 16, a reaction force transmitted from the support section 3 to the back part 8.

The force transmission arrangement comprises a joint arrangement for providing at least one rotational and/or translational degree of freedom between the back part 8 and the pelvic strap 16. Preferably, the joint arrangement comprises at least one joint for providing the at least one rotational and/or translational degree of freedom between the back part 8 and the pelvic strap 16. The joint is, for example, the force transmission element joint 17. The force transmission path preferably runs via the at least one joint.

The force transmission arrangement also comprises the in particular rigid force transmission element 18 extending from the back part 8 to the pelvic strap 16, via which rigid force transmission element 18 the force transmission path runs.

The force transmission element 18 is expediently capable of transmitting a horizontally and/or vertically acting force.

The term rigid refers in particular to dimensionally stable. A rigid force transmission element is in particular a force transmission element that is dimensionally stable—i.e. in particular retains its shape—under the load of its own weight and/or under the load of the exoskeleton 20 and/or when subjected to the reaction force. The term rigid force transmission element is intended in particular to differentiate it from a strap. The rigid force transmission element can also be referred to as a stiff force transmission element. The force transmission element 18 is preferably made of metal, in particular magnesium, for example magnesium alloy AZ91.

Preferably, the force transmission path is the only path for transmitting the reaction force from the back part 8 to the pelvic strap 16, so that the entire reaction force transmitted from the back part 8 to the pelvic strap 16 passes via the rigid force transmission element 18. In particular, the entire reaction force transmitted from the back part 8 to the pelvic strap 16 runs sequentially via the rigid force transmission element 18 and the joint. In particular, the force transmission path is not divided.

Preferably, the force transmission element 18 is connected to the pelvic strap 16 only via the joint arrangement, in particular only via the joint. Expediently, apart from the rigid force transmission element 18, there is no other rigid element for transmitting force between the back part 8 and the pelvic strap 16. In particular, there is no rigid element separate from the rigid force transmission element 18 for transmitting force between the back part 8 and the pelvic strap 16. In particular, apart from the rigid force transmission element 18 and the shoulder straps 19, there is no other element connecting the back part 8 and the pelvic strap 16.

Expediently, the pelvic strap 16 is connected only at one point to the force transmission element 18, which is designed in particular as a sword. As an example, the force transmission element 18 is designed as a flat profile, which is preferably attached to the back part 8 so that it can be pulled out. In this way, the exoskeleton 20 can be adapted to the user's back length. The connection—in particular the force transmission element joint 17—between the force transmission element 18 and the pelvic strap 16 can also be referred to as a sacral connection or sacral joint. Expediently, this connection, in particular the force transmission element joint 17, is located at the level of the user's sacrum.

The joint arrangement, preferably the joint, in particular the force transmission element joint 18, preferably provides three rotational degrees of freedom. Preferably, the joint arrangement comprises a ball joint and/or a swivel joint, in particular a translationally displaceable swivel joint. Preferably, the joint, in particular the force transmission element joint 17, is designed as a ball joint. The force transmission path runs expediently one after the other via the rigid force transmission element 18 and via the force transmission element joint 17 to the pelvic strap 16.

Preferably, the joint, in particular the force transmission element joint 17, is arranged between the back part 8 and the pelvic strap 16. Preferably, the joint, in particular the force transmission element joint 17, is arranged between the rigid force transmission element 18 and the pelvic strap 16, in particular at the level of the pelvic strap 16. As an example, the joint, in particular the force transmission element joint 17, is arranged on a rearwardly directed outer side of the pelvic strap 16. Expediently, the force transmission arrangement, in particular the force transmission element 18 and/or the joint, in particular the force transmission element joint 17, is arranged centrally in the width direction y of the exoskeleton 20.

Preferably, the force transmission element 18 comprises a rigid strip-shaped strip section 301 which extends over at least 50% of the vertical extent, i.e. in particular the length, of the force transmission element 18. The strip section 301 can be seen, for example, in FIG. 5. Expediently, the force transmission element 18, in particular the strip section 301, is aligned with its largest side in terms of area parallel to the y-direction and/or normal to the x-direction. In particular, the entire reaction force transmitted from the back part 8 to the pelvic strap 16 runs via the strip section 301, in particular via at least a part of the strip section 301.

As an example, the joint arrangement comprises an extension joint 302 with at least one translational degree of freedom, via which the vertical extension of the exoskeleton 20 can be adjusted. In particular, the extension joint 302 can be used to adjust the length of the joint arrangement to the length of a user's back. An exemplary embodiment of the extension joint 302 is shown in FIG. 8. As an example, the force transmission element 18 is mounted on the back part 8 via the extension joint 302. In particular, the force transmission element 18 is displaceably mounted on the back part 8 via the extension joint 302. By way of example, the force transmission element 18 can optionally be pushed into the back part 8 via the extension joint 302 in order to reduce the vertical extension of the exoskeleton 20 or can be pulled out of the back part 8 in order to increase the vertical extension of the exoskeleton 20. The extension joint 302 expediently comprises an actuating element 303, via which the user can fix the force transmission element 18 relative to the back part 8, so that the force transmission element 18 cannot be displaced relative to the back part 8.

By way of example, markings, in particular numbers, are provided on the force transmission element 18, which are distributed in the longitudinal direction of the force transmission element 18 and which expediently indicate to the user a currently set position of the force transmission element 18 relative to the back part 8. For example, the extension joint 302 has a display structure, in particular a window 304, at which the marking, in particular the number, is positioned in accordance with the currently set position of the force transmission element 18.

The extension joint 302 is expediently arranged on the inside of the back part 8—i.e. in particular on the side of the back part 8 facing the user's back.

By way of example, the force transmission arrangement comprises the extension joint 302, the force transmission element 18 and the force transmission element joint 17. By way of example, the joint arrangement comprises the extension joint 302 and the force transmission element joint 17. By way of example, the force transmission path runs sequentially (in the order indicated) from the back part 8 via the extension joint 302 to the force transmission element 18 and from the force transmission element 18 via the force transmission element joint 17 to the pelvic strap 16. This force transmission path is expediently the only path on the exoskeleton 20 for transmitting the reaction force from the back part 8 to the pelvic strap 16. Expediently, force transmission via the exoskeleton from the back part to the pelvic strap is possible exclusively via the force transmission path and/or via the shoulder straps 19.

The joint arrangement, in particular the joint, preferably the force transmission element joint 17, comprises, by way of example, a first joint section 305 and a second joint section 306, as shown, for example, in FIG. 5. The at least one rotational degree of freedom is provided in particular between the first joint section 305 and the second joint section 306. By way of example, the first joint section 305 is associated with the force transmission element 18 and/or the second joint section 306 is associated with the pelvic strap 16. Expediently, the force transmission path runs sequentially via the first joint section 305 and the second joint section 306. For example, the first joint section 305 is a part, in particular a lower part, of the force transmission element 18. In particular, the first joint section 305 adjoins the strip section 301 at the bottom.

By way of example, the second joint section 306 is attached to the pelvic strap 16, as shown, for example, in FIG. 9. Exemplarily, the second joint section 306 comprises an outer fastening section 307, which is in particular configured as an outer fastening plate. Expediently, the second joint section 306 further comprises at least one inner fastening section 308, which for example comprises at least one inner fastening plate.

The outer fastening section 307 and the inner fastening section 308 expediently serve to introduce the force transmitted by the force transmission element 18, in particular the reaction force, into the pelvic strap 16. Expediently, the outer fastening section 307 and/or the inner fastening section 308 extend in the z-direction over at least half of the z-extension of the pelvic strap 16. As an example, the y-extension of the outer fastening section 307 and/or the inner fastening section 308 is between 15 and 20 cm.

In FIG. 5, the pelvic strap 16 arranged between the inner fastening section 308 and the outer fastening section 307 is not shown for better visualization.

Preferably, the outer fastening section 307 is on the outside—i.e. in particular on the side facing away from the user—of the pelvic strap 16, and the inner fastening section 308 is preferably on the inside—i.e. in particular on the side facing the user—of the pelvic strap 16. The outer fastening section 307 and the inner fastening section 308 are expediently fastened to one another, in particular by one or more screws which extend, for example, through the pelvic strap 16.

Preferably, the force transmission element joint 17 comprises a ball section 309, which by way of example is part of the second joint section 306 and in particular is attached to the outer fastening section 307. The ball section 309 is shown in FIG. 6. For example, the ball section 309 protrudes rearwardly from the preferably plate-shaped outer fastening section 307, exemplarily in the (in particular negative) x-direction. The ball section 309 has a ball head 310.

As an example, the ball head is made of a plastic, for example glass fiber-reinforced polyamide, in particular Schulamid 6 GF30.

The ball head 310 is preferably flattened. In particular, the ball head 310 has the shape of a flattened ball. In particular, the side of the ball head 310 facing away from the pelvic strap 16 is flattened. For example, the ball head 310 has the shape of a sphere, part of which has been cut off in the vertical plane. The flattened ball head preferably provides a more compact joint arrangement. In particular, the flattened ball head makes it possible to reduce a lever arm acting on the second joint section 306 as a result of the introduction of force from the first joint section 305.

Expediently, the force transmission element joint 17 further comprises a ball head receptacle 311, which receives the ball head 310, and in particular is part of the first joint section 305.

The ball head receptacle 311 is preferably made of metal. Expediently, the ball head section 309 is removable from the exoskeleton 20, in particular together with the outer fastening section 307, for example by loosening corresponding screws and by unlocking the locking mechanism 312 explained below, and then replaceable, for example when the ball head 310 is worn.

According to an alternative embodiment, the ball section 309 is part of the first joint section 305 and the ball head receptacle 311 is part of the second joint section 306.

As already mentioned above, the joint, in particular the force transmission element joint 17, has the first joint section 305 and the second joint section 306. The second joint section 306 can in particular be removed from the first joint section 305 without tools, for example in order to remove the pelvic strap 16 (in particular together with the second joint section 305) from the back part 8 and/or from the rigid force transmission element 18.

Preferably, the exoskeleton 20 comprises a locking mechanism 312 for locking the second joint section 306 to the first joint section 305. In an exemplary embodiment, the locking mechanism 312 comprises a manually operable actuating element 313, the actuation of which can be used to release the locking mechanism. Preferably, the locking mechanism 312 is a purely mechanical locking mechanism.

FIGS. 6 and 7 show an exemplary embodiment of the locking mechanism 312. FIG. 6 shows a section through an x-z plane and FIG. 7 shows a section through a y-z plane. The sections each run through the ball head 310.

Expediently, the locking mechanism 312 serves to selectively lock the ball head 310 in the ball head receptacle 311 so that the ball head 310 cannot be removed from the ball head receptacle 311, or to release the ball head 310 relative to the ball head receptacle 311 so that the ball head 310 can be removed from the ball head receptacle 311. The locking mechanism 312 is preferably operable without the aid of tools.

In an exemplary embodiment, the locking mechanism has a locking part 314, which is expediently mechanically connected to the actuating element 313 and, in particular, can be moved via the actuating element 313 in order to move the locking part 314 selectively into a locking position or into a release position. In the locking position, the locking part 314 holds the ball head 310 at least partially in a locking recess 315, whereby the ball head 310 is locked in the ball head receptacle 311. By way of example, the locking recess 315 is arranged above the ball head 310 and/or the locking part 314 is expediently arranged below the ball head 310.

As an example, the locking part 314 can be rotated via the actuating element 313 about an axis of rotation extending in particular parallel to the y-direction in order to move the locking part 314 by rotation either into the locking position or the release position.

The locking part 314 expediently comprises a release recess 316, which in the release position faces the ball head 310, so that the ball head 310 can leave the locking recess 315 by moving into a space released by the release recess 316. In the locking position, the release recess 316 does not face the ball head 310.

The actuating element 313 is preferably designed as an operating lever and, in particular, can be rotated about an axis of rotation running parallel to the y-direction, for example by the user, in order to move the locking part 314 either into the locking position or the release position. For example, a rotation of 90 degrees is required to move the locking part 314 from the locking position to the release position.

By way of example, the actuating element 313 is part of the first joint section 305, in particular part of the force transmission element 18. In particular, the actuating element 313 is arranged on a lateral edge (in the width direction) of the force transmission element 18. In particular, the actuating element 313 is integrated into the force transmission element 18 in such a way that the actuating element 313 continuously continues a lateral outer contour (in the width direction) of the force transmission element 18. The part of the force transmission element 18 without the actuating element 313 shall also be referred to as the force transmission element body 317. The force transmission element 18 comprises the force transmission element body 317 and the actuating element 313. A recess is provided in the force transmission element body, in particular at the lateral edge (in the width direction), in which the actuating element 313 is arranged. The recess is expediently the same size as the actuating element 313 and completely accommodates the actuating element 313. Coming from above along the lateral outer contour of the force transmission element body 317, the recess is formed by a step 318 in the lateral outer contour inwards towards the center (in the width direction) of the force transmission element 18 and a subsequent vertically downwardly extending section 319 of the lateral outer contour of the force transmission element body 317.

Preferably, two different, successive actuating movements of the actuating element 313 are required to release the locking mechanism.

In an exemplary embodiment, the actuating element 313 can selectively be set to a securing state or an actuating state, in particular by the user, and can expediently be set to the release position only in the actuating state, and in particular not in the securing state. In particular, a first actuating movement of the actuating element 313, for example pulling the actuating element 313 laterally outwards in the width direction, is required in order to move the actuating element 313 from the locking state to the actuating state, and then a second actuating movement, in particular a rotation of the actuating element 313 about an axis of rotation extending parallel to the y-direction, is required in order to move the actuating element 313 in the actuating state from the locking position to the release position.

In an exemplary embodiment, the actuating element 313 has a first engagement section 321 which, in the securing state, engages with a second engagement section 322 of the force transmission element body 317 and thereby prevents the actuating element 313 from being moved into the release position. By way of example, the first engagement section 321 is designed as a projection, in particular projecting laterally, and the second engagement section 322 is designed as a recess, in particular at the side. By pulling the actuating element 313 laterally outwards in the width direction, the engagement between the first engagement section 321 and the second engagement section 322 is released, so that rotation of the actuating element 313 about an axis of rotation running parallel to the y-direction is made possible.

According to an alternative embodiment (not shown), the ball head can be inserted laterally into the ball head receptacle and the locking mechanism closes the ball head receptacle laterally. In this embodiment, the locking mechanism is expediently not arranged in the same plane as a main force direction. Preferably, the locking mechanism comprises an actuating element preferably designed as an operating lever, which is shaped, for example, like the actuating element 313 discussed above. The actuating element, in particular the operating lever, comprises a locking section which serves in particular to laterally lock the ball head receptacle. As an example, the actuating element can be rotated about an axis of rotation extending in particular parallel to the y-direction in order to move the locking section by rotation selectively into the locking position or into the release position. In the release position, the locking section releases a recess, for example an opening, in the first joint section 305, for example in the y-direction. In the locking position, the recess or opening is blocked by the locking section, in particular blocked in such a way that the second joint section 306 cannot be removed from the first joint section 306.

Alternatively, it is also possible for the ball head to be attached to the force transmission element and for the ball head mount to be arranged on the pelvic strap.

With reference to FIGS. 10 to 14, variants of the joint, in particular the force transmission element joint 17, will be discussed below.

According to the variant shown in FIG. 10, the first joint section 305 has a pin section 323 which is in engagement with a first bearing element 324. Expediently, the second joint section 306 is configured as a plate attached to the pelvic strap 16 and the pin section 323 engages in an opening of the plate. Expediently, the pin section 323 is articulated in the opening by means of a bearing. The bearing is a ball bearing or a plain bearing, in particular a self-aligning plain bearing. The bearing is formed by the first bearing element 324 and a second bearing element 325 of the second joint section 306 arranged in the opening.

According to the variant shown in FIG. 11, the second joint section 306, which is designed in particular as a plate and/or attached to the pelvic strap, has a vertically oriented elongated hole 326, in which a pin 327 arranged on the force transmission element 18 (as the first joint section 305) is guided.

Alternatively, the elongated hole can be part of the force transmission element and the pin part of the second joint section.

The joint is preferably designed as a swivel joint, in particular as a translationally displaceable swivel joint.

For example, the pin 327 can be moved rotationally (about a horizontal axis of rotation) relative to the second joint section 306, so that the variant according to FIG. 11 provides a swivel joint. The swivel joint is expediently translationally movable via a displacement of the pin 327 in the elongated hole 326. Preferably, the joint defines a linear path—for example by means of the linearly elongated hole 326—for a movement, in particular a translational movement, of the back part 8 relative to the pelvic strap 16.

When the user is standing upright, the pin 327 guided in the elongated hole 326 rests against the lower end of the elongated hole 326. If the user bends forward, the pin 327 can move upwards within the elongated hole 326 and thus give the user more free space in the area of his back in the bent position.

FIGS. 13 and 14 show variants in which the joint defines a non-linear path for a movement, in particular a translational movement, of the back part 8 relative to the pelvic strap 16. In particular, the non-linear path allows a rotational movement, especially bending, of the user.

In an exemplary embodiment, the second joint section 306 has an elongated hole 326 that defines the non-linear path. The non-linear path is expediently concave (with respect to the user), as shown in FIG. 13, or convex (with respect to the user), as shown in FIG. 14.

For example, in an x-z side view, the elongated hole 326 has the shape of an arc, the imaginary center of which lies in the user's body (see FIG. 13) or behind the user (see FIG. 14).

The force transmission element 18 comprises a pin 327, which forms the first joint section 305 and is guided in the elongated hole 326.

Optionally, the second joint section 306 is rotatably mounted on the pelvic strap 16, in particular via a rotatable mounting plate 328.

With reference to FIG. 12, further variants are to be discussed, in which the force transmission element joint 17 can be designed in particular as a linear guide, which expediently enables a translational displacement of the force transmission element 18 (as first joint section 305) relative to the second joint section 306 attached to the pelvic strap 16. Purely by way of example, the second joint section 306 is attached to the pelvic strap 16 via a pivot bearing 329 and is thus rotatably mounted on the pelvic strap 16, in particular about an axis of rotation extending parallel to the width direction.

The second joint section 306 is expediently designed to be elongated and aligned vertically with its longitudinal axis. Preferably, the second joint section 306 has a section 330 extending towards the back of the user, which is designed in particular as a step, kink or curve in the course of the second joint section 306. In this way, the linear guide can be positioned closer to the user's back.

For example, the linear guide is designed with a rail in a socket that has been provided with a sliding coating. The design makes it possible in particular to compensate for a back extension and to maintain a minimum distance between the back and the linear guide. This expediently results in no impairment of a bending process.

According to a further variant, the force transmission element joint 17, in particular the linear guide, can be designed as a cylindrical joint. The cylindrical joint offers degrees of freedom in translation and rotation. Preferably, both bending and rotating the upper body are possible without restrictions.

According to a further variant, the linear guide can be a linear guide with industrial bearings.

1. An exoskeleton, comprising:
a base section for attachment to a torso of a human body,
a support section movably coupled to the base section for supporting an arm of the human body,
an actuator device acting on the support section for providing a support force for the arm, wherein
the base section comprises a back part, a pelvic strap and a force transmission arrangement extending from the back part to the pelvic strap, which force transmission arrangement provides a force transmission path from the back part to the pelvic strap in order to transmit, to the pelvic strap, a reaction force transmitted from the support section to the back part,
the force transmission arrangement comprises a joint arrangement for providing at least one rotational and/or translational degree of freedom between the back part and the pelvic strap, and
the force transmission arrangement further comprises a rigid force transmission element extending from the back part to the pelvic strap, via which rigid force transmission element the force transmission path runs.

2. The exoskeleton according to claim 1, wherein the force transmission path is the only path for transmitting the reaction force from the back part to the pelvic strap, so that the entire reaction force transmitted from the back part to the pelvic strap passes via the rigid force transmission element.

3. The exoskeleton according to claim 1, wherein the force transmission element is connected to the pelvic strap only via the joint arrangement.

4. The exoskeleton according to claim 1, wherein the joint arrangement provides three rotational degrees of freedom.

5. The exoskeleton according to claim 1, wherein the joint arrangement comprises a ball joint and/or a swivel joint.

6. The exoskeleton according to claim 1, wherein the joint arrangement comprises a joint which is arranged between the rigid force transmission element and the pelvic strap.

7. The exoskeleton according to a preceding claim 1, wherein the force transmission arrangement is arranged centrally in the width direction of the exoskeleton.

8. The exoskeleton according to claim 1, wherein the force transmission element comprises a rigid strip-shaped strip section extending over at least 50% of the vertical extent of the force transmission element.

9. The exoskeleton according to claim 1, wherein the joint arrangement comprises an extension joint with at least one translational degree of freedom, via which the vertical extension of the exoskeleton is adjustable.

10. The exoskeleton according to claim 10, wherein the force transmission element is mounted on the back part via the extension joint.

11. The exoskeleton according to claim 1, wherein the pelvic strap is connected to the back part via the force transmission arrangement.

12. The exoskeleton according to claim 1, wherein the joint arrangement has a first joint section and a second joint section, and the second joint section can be removed from the first joint section in order to remove the pelvic strap from the back part and/or from the rigid force transmission element.

13. The exoskeleton according to claim 12, further comprising a locking mechanism for locking the second joint section to the first joint section, wherein the locking mechanism has a manually operable actuating element, via the actuation of which the locking can be released.

14. The exoskeleton according to claim 13, wherein two different, successive actuating movements of the actuating element are required to release the locking.

15. The exoskeleton according to claim 1, wherein the joint arrangement defines a linear or non-linear path for a translational movement of the back part relative to the pelvic strap.

16. A method of operating an exoskeleton according to claim 1, comprising the step of: transmitting the reaction force from the support section to the back part and from the back part via the force transmission path further to the pelvic strap.

17. The exoskeleton according to claim 1, wherein the joint arrangement comprises a translationally displaceable swivel joint.

18. The exoskeleton according to claim 6, wherein the joint is arranged at the level of the pelvic strap.

19. The exoskeleton according to claim 1, wherein the force transmission element is arranged centrally in the width direction of the exoskeleton.

20. The exoskeleton according to claim 1, wherein the pelvic strap is connected to the back part via the force transmission arrangement in a tool-free detachable manner.

21. The exoskeleton according to claim 12, wherein the second joint section can be removed from the first joint section in a tool-free manner in order to remove the pelvic strap from the back part and/or from the rigid force transmission element.
